(19) United States
(12) Patent Application Publication
(10) Pub. No.: US 2015/0263363 A1
(43) Pub. Date: Sep. 17, 2015

(54) Fuel Cell Arrangement and Method for Operating the Fuel Cell Arrangement

(71) Applicant: Bayerische Motoren Werke Aktiengesellschaft, Muenchen (DE)

(72) Inventors: Stefan HAASE, Muenchen (DE); Andreas BUCHNER, Steinebach (DE); Michael BAUER, Unterfoehring (DE); Martin SCHERRER, Poing (DE)

(21) Appl. No.: 14/728,445

(22) Filed: Jun. 2, 2015

Related U.S. Application Data
(63) Continuation of application No. PCT/EP2013/073407, filed on Nov. 8, 2013.

(30) Foreign Application Priority Data
Dec. 3, 2012 (DE) 10 2012 222 105.0

(51) Int. Cl. H01M 8/04; H01M 8/06

(52) U.S. Cl. CPC H01M 8/04074; H01M 8/0687; H01M 8/04037; H01M 8/04201

(57) ABSTRACT

A fuel cell arrangement, in particular for a motor vehicle, includes a tank for storing a carrier fluid mixed with hydrogen, a separating device for separating hydrogen from the carrier fluid, a fuel cell for generating electrical energy from the hydrogen, and a heating arrangement for heating the carrier fluid mixed with hydrogen. The heating arrangement includes a first heat exchanger for heating the carrier fluid by way of a carrier fluid return line, and/or a second heat exchanger for heating the carrier fluid by way of the waste heat of the fuel cell, and/or a third heat exchanger for heating the carrier fluid by way of a compressed intake air.

### CROSS REFERENCE TO RELATED APPLICATIONS

This application is a continuation of PCT International Application No. PCT/EP2013/073407, filed Nov. 8, 2013, which claims priority under 35 U.S.C. §119 from German Patent Application No. 10 2012 222 105.0, filed Dec. 3, 2012, the entire disclosures of which are herein expressly incorporated by reference.

### BACKGROUND AND SUMMARY OF THE INVENTION

The present invention relates to a fuel cell arrangement and is based on DE 10 2006 007 782 A1. A fuel cell arrangement, in particular for a motor vehicle, includes a tank for holding a carrier fluid which is mixed with hydrogen, a separation device for separating hydrogen from the carrier fluid, a fuel cell for generating electrical energy from the hydrogen, and a heating arrangement for heating the carrier fluid which is mixed with hydrogen. In addition, the invention relates to a method for operating such a fuel cell arrangement.

Fuel cell arrangements (arrays) are used for generating electrical energy in motor vehicles. The electrical energy serves, inter alia, for driving the motor vehicle. Hydrogen is required to operate the fuel cell. The storage of the hydrogen in liquid or gaseous form is costly and risky. As an alternative, it is possible to use carrier fluids in which the hydrogen is mixed. The carrier fluids with the hydrogen can be stored in simple tanks and refilled like conventional fuels. The carrier fluid which is mixed with hydrogen however, has to be heated to a specific temperature in order to permit the hydrogen to be separated from the carrier fluid (=“dehydrogenation”). DE 10 2006 007 782 A1 contains information as to how waste heat of such a fuel cell arrangement can be used for the dehydrogenation of the carrier fluid.

The object of the present invention is to provide a further measure permitting a carrier fluid, which is enriched with hydrogen, to be heated in as energy-efficient and operationally reliable a fashion as possible in a fuel cell arrangement.

This and other objects are achieved by a fuel cell arrangement including a tank, a separation device, a fuel cell and a heating arrangement. The tank serves to hold a carrier fluid which is mixed with hydrogen. In particular, carbazole is used as the carrier fluid. Hydrogen can be separated from the carrier fluid by way of the separation device. Electrical energy is generated in the fuel cell by the hydrogen and ambient air. The electrical energy is used, in particular, to drive a motor vehicle. The heating arrangement serves to heat the carrier fluid, in particular to 150° C. to 250° C., with the result that it is possible to separate off the hydrogen in the separation device.

In the fuel cell arrangement according to the invention, it is possible to heat up the carrier fluid, in particular in the event of a cold start, very efficiently and quickly by use of the heating arrangement. For this purpose, the heating arrangement has three heat exchangers which can be used either individually or in combination with one another within the scope of the invention. The first heat exchanger utilizes the hot carrier fluid which has already given off the hydrogen. In the first heat exchanger, the heat of a carrier fluid return line is therefore used to heat the carrier fluid which comes from the tank and which is still mixed with hydrogen. In addition, a second heat exchanger is provided. This second heat exchanger uses waste heat of the fuel cell. In addition, a third heat exchanger is provided. In the third heat exchanger, the heat from compressed intake air is used to heat the carrier fluid.

In order to operate the fuel cell, ambient air is compressed. Heat is produced in the process. In the third heat exchanger, the heat can either be extracted directly from the compressor or the heat is taken from the compressed intake air. In the fuel cell arrangement according to the invention, either just one of the three heat exchangers, two of the three heat exchangers or all three heat exchangers can be used. The sequence of the three heat exchangers for heating the carrier fluid is selected in accordance with the temperature of the carrier fluid, that of the fuel cell and that of the compressed intake air. The heat exchangers can be used in a different sequence by way of corresponding lines and valves in the fuel cell arrangement.

Furthermore, an electric heater can be provided. With the electric heater it is possible to carry out further heating of the carrier fluid upstream of the separation device. The electric heater is arranged, in particular downstream of the heat exchangers and upstream of the separation device. If the heat exchangers which are used do not permit sufficient heating of the carrier fluid which is mixed with hydrogen, further heating can be carried out with the electric heater upstream of the separation device.

The carrier fluid return line leads, in particular, from the separation device to a collecting container. The carrier fluid return line can be diverted into the first heat exchanger between the separation device and the collecting container.

The first heat exchanger is preferably arranged upstream of the second and/or third heat exchangers, with the result that the heat from the carrier fluid return line is used first, and the heat of the fuel cell or of the intake air is used subsequently if a second or third heat exchanger is installed.

Furthermore, a fourth heat exchanger can be provided. The fourth heat exchanger also uses the heat of the carrier fluid return line. The fourth heat exchanger is arranged downstream of the second and/or third heat exchangers. As a result, given a correspondingly high temperature in the carrier fluid return line, the temperature thereof can also still be used downstream of the second or third heat exchanger.

Instead of the use of a fourth heat exchanger, it is also possible to use the first heat exchanger optionally upstream or downstream of the second or third heat exchanger, by way of corresponding valves and lines.

The second heat exchanger is preferably integrated directly into the fuel cell. This means that in the second heat exchanger the carrier fluid which is mixed with hydrogen is conducted through the fuel cell.

The invention also includes a method for operating a fuel cell arrangement. The method has the following steps: the carrier fluid which is mixed with hydrogen is heated with the waste heat of the fuel cell (second heat exchanger) and/or with the compressed intake air (third heat exchanger). Before and/or after this heating, the heat of the carrier fluid return line can be used for additional heating, referred to as pre-heating or post-heating: it is therefore possible for “pre-heating” of the carrier fluid which is mixed with hydrogen to be carried out by way of the carrier fluid return line. Additionally or alternatively to this, “post-heating” of the carrier fluid which is mixed with hydrogen is possible. The pre-heating and post-heating can be carried out with a correspondingly switched heat exchanger (first heat exchanger) or with two separate heat exchangers (first and fourth heat exchangers). Carbazole can preferably be used as the carrier fluid.

The following operating strategy is preferably provided for the method: firstly, a shut-off throttle valve is closed and the compressor for the intake air is operated with high load. The intake air is heated here to over 100° C. The cooling circuit heats the cooling water up, and a charge air cooler lowers the temperature to 90° C. The diaphragm of the fuel cell is loaded with hot air within the operating limits. The hot intake air brings about rapid heating-up of the diaphragm here and causes the reaction water to be transported away and prevents the formation of ice crystals in the water. The waste heat of the charge air cooler is used to heat the fuel cell and the vehicle. Furthermore, the waste heat is also used to pre-heat the high-voltage battery in order to pre-heat the passenger compartment, to pre-heat cooling circuits for the electric motor and/or the power electronics. An additional compressor capacity is used as a way of relieving the loading on the fuel cell, in order to avoid a heating resistance.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a schematic diagram of an inventive fuel cell arrangement according to an exemplary embodiment, i.e. an inventive fuel cell arrangement used in a motor vehicle.

### DETAILED DESCRIPTION OF THE DRAWING

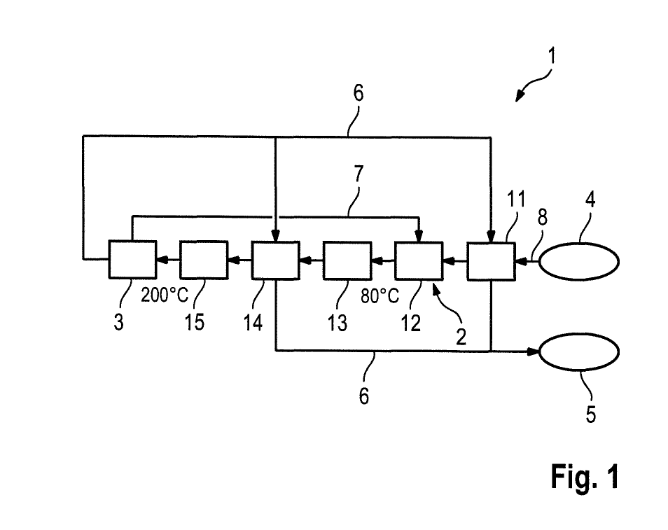

Referring to FIG. 1, the fuel cell arrangement 1 includes a fuel cell 2, a separation device 3, a tank 4 and a collecting container 5. A carrier fluid which is mixed with hydrogen is stored in the tank 4. The carrier fluid is heated along a feed line 8 and reaches the separation device 3 at approximately 200° C. In the separation device 3, hydrogen is separated from the carrier fluid and fed to the fuel cell 2 via a hydrogen line 7. The carrier fluid, from which hydrogen has been extracted, is conducted out of the separation device 3 into the collecting container 5 via a carrier fluid return line 6.

A plurality of devices for heating the carrier fluid are provided along the feed line 8 between the tank 4 and the separation device 3: a first heat exchanger 11 uses the heat in the carrier fluid return line 6 to heat the carrier fluid, mixed with hydrogen, in the feed line 8. A second heat exchanger 12 is integrated into the fuel cell 2. In the second heat exchanger 12, the carrier fluid which is mixed with hydrogen is conducted through the fuel cell 2 and therefore heated. A third heat exchanger 13 uses compressed intake air or the waste heat of a corresponding compressor. In a fourth heat exchanger 14, the heat in the carrier fluid return line 6 is in turn used for heating. The carrier fluid which is mixed with hydrogen is heated by way of an electric heater 15 using electrical energy.

The four heat exchangers 11 to 14 and the electric heater 15 can be used individually or in combination with one another. At least the first heat exchanger 11, the second heat exchanger 12 or the third heat exchanger 13 is used according to the invention.

The sequence of the first heat exchanger 11, of the second heat exchanger 12 and of the third heat exchanger 13 is random and ultimately dependent on the heat in the carrier fluid return line 6, in the fuel cell 2 and in the intake air. The sequence illustrated in the figure is preferably selected.

Instead of using the fourth heat exchanger 14, the first heat exchanger 11, in which the feed line 8 and the carrier fluid return line 6 are regulated by corresponding valves and control elements, can be used.

In particular, in the case of a starting process of the fuel cell arrangement 1, the first heat exchanger 11 is used first. In the case of a correspondingly high temperature in the carrier fluid return line 6, the fourth heat exchanger 14 is then used alternatively or additionally to the first heat exchanger 11.

### LIST OF REFERENCE NUMBERS

1 Fuel cell arrangement
2 Fuel cell
3 Separation device
4 Tank
5 Collecting container
6 Carrier fluid return line
7 Hydrogen line
8 Feed line
11 First heat exchanger
12 Second heat exchanger
13 Third heat exchanger
14 Fourth heat exchanger
15 Electric heating device

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A fuel cell arrangement, comprising:
a tank for storing a carrier fluid in which hydrogen is mixed;
a separation device operatively configured to separate the hydrogen from the carrier fluid;
a fuel cell operatively configured to generate electrical energy from the hydrogen; and
a heating arrangement configured to heat the carrier fluid in which the hydrogen is mixed, the heating arrangement comprising first, second and third heat exchangers, wherein
the first heat exchanger is configured to heat the carrier fluid via a carrier fluid return line,
the second heat exchanger is configured to heat the carrier fluid via waste heat from the fuel cell, and
the third heat exchanger is configured to heat the carrier fluid via compressed intake air, whereby one or more of the first, second and third heat exchangers are operated to heat the carrier fluid.

2. The fuel cell arrangement according to claim 1, further comprising:
an electric heater configured to heat the carrier fluid in which the hydrogen is mixed.

3. The fuel cell arrangement according to claim 2, wherein the electric heater is arranged downstream of the first, second and third heat exchangers.

4. The fuel cell arrangement according to claim 1, wherein the carrier fluid return line conducts the carrier fluid, after the hydrogen has been separated from the carrier fluid in the separation device, from the separation device to a collecting container.

5. The fuel cell arrangement according to claim 1, wherein the first heat exchanger is arranged upstream of the second and/or third heat exchanger.

6. The fuel cell arrangement according to claim 3, wherein the first heat exchanger is arranged upstream of the second and/or third heat exchanger.

7. The fuel cell arrangement according to claim 1, further comprising:
a fourth heat exchanger configured to heat the carrier fluid via the carrier fluid return line, wherein
the fourth heat exchanger is arranged downstream of the second and/or third heat exchanger.

8. The fuel cell arrangement according to claim 6, further comprising:
a fourth heat exchanger configured to heat the carrier fluid via the carrier fluid return line, wherein
the fourth heat exchanger is arranged downstream of the second and/or third heat exchanger.

9. The fuel cell arrangement according to claim 1, wherein the second heat exchanger is integrated in the fuel cell, whereby the carrier fluid is conducted through the fuel cell in the second heat exchanger.

10. The fuel cell arrangement according to claim 8, wherein the second heat exchanger is integrated in the fuel cell, whereby the carrier fluid is conducted through the fuel cell in the second heat exchanger.

11. The fuel cell arrangement according to claim 1, wherein the fuel cell arrangement is a motor vehicle fuel cell arrangement and the carrier fluid is carbazole.

12. A method for operating a fuel cell arrangement having a tank that stores a carrier fluid in which hydrogen is mixed, a separation device that separates hydrogen from the carrier fluid, a fuel cell that generates electrical energy from the hydrogen, and a heating arrangement configured to heat the carrier fluid in which the hydrogen is mixed, the heating arrangement having first, second and third heat exchangers, wherein the method comprises the acts of:
preheating, via the first heat exchanger, the carrier fluid in which the hydrogen is mixed by way of a carrier fluid return line;
heating, via the second heat exchanger, the carrier fluid in which the hydrogen is mixed by way of waste heat of the fuel cell and/or compressed intake air,
the heating via the second heat exchanger occurring after the preheating of the carrier fluid; and
subsequently heating the carrier fluid in which the hydrogen is mixed via another carrier fluid line, the subsequent heating occurring after the heating of the carrier fluid with the waste heat of the fuel cell and/or the compressed intake air.

13. The method according claim 12, wherein the carrier fluid is carbazole.

14. The method according to claim 12, wherein the heating of the carrier fluid comprises both heating the carrier fluid with the waste heat and with the compressed intake air via separate heat exchangers.
